(19) United States
(12) Patent Application Publication
(10) Pub. No.: US 2022/0238133 A1
(43) Pub. Date: Jul. 28, 2022

(54) METHOD OF SPECIFYING GENERATION POINT OF ABNORMAL SOUND AND APPLICATION PROGRAM

(71) Applicant: TOYOTA JIDOSHA KABUSHIKI KAISHA, Toyota-shi (JP)

(72) Inventor: Tadashi IBARAGI, Nagoya-shi (JP)

(73) Assignee: TOYOTA JIDOSHA KABUSHIKI KAISHA, Toyota-shi (JP)

(21) Appl. No.: 17/581,381

(22) Filed: Jan. 21, 2022

(30) Foreign Application Priority Data
Jan. 25, 2021 (JP) 2021-009401

(51) Int. Cl. G10L 21/14; G10L 25/18; G06V 10/74; G06V 10/75

(52) U.S. Cl. CPC G10L 21/14; G06V 10/758; G06V 10/761; G10L 25/18

(57) ABSTRACT

A CPU operates a speaker to select and reproduce frequency components of sounds that are candidates of a generation point of abnormal sound. The CPU sets the frequency of the sound indicated via a touchpanel, among the reproduced sounds, as an indication frequency. The CPU extracts the indication frequency component from sound data recorded while a mobile terminal is arranged in proximity to each of a plurality of regions obtained by dividing a target object, and calculates a sound pressure level thereof. The CPU transmits the sound data on the region where the sound pressure level is highest to an analyzer. The analyzer specifies the generation point of the abnormal sound based on the received sound data.

### CROSS-REFERENCE TO RELATED APPLICATION

This application claims priority to Japanese Patent Application No. 2021-009401 filed on Jan. 25, 2021, incorporated herein by reference in its entirety.

### BACKGROUND

### 1. Technical Field

The present disclosure relates to a method of specifying a generation point of abnormal sound and an application program.

### 2. Description of Related Art

For example, Japanese Unexamined Patent Application Publication No. 9-196825 discloses a device that detects abnormality based on output when image data is input into a neural network and output when waveform data obtained by analyzing the frequency of an acoustic signal is input into the neural network.

### SUMMARY

In the case of objects that generate sound at normal times, such as vehicles and the like, the sound pressure level of an abnormal sound generated when abnormality occurs does not necessarily exceed the sound pressure level of the sound generated at the normal times. Therefore, in order to make it possible to specify the generation point of abnormality by using a neural network as described above, the neural network has much information to identify, which often makes it hard for the neural network to learn. Furthermore, it is also necessary to identify the relationship between an image represented by image data and sound represented by an acoustic signal. However, it can be difficult for a person to identify the generation point of sound relating to abnormality. Therefore, to specify the relationship, a high level information processing ability is necessary.

Hereinafter, measures to solve the stated problems and the operation effects thereof will be described.

1. A method of specifying a generation point of abnormal sound includes: a reproduction step; an indication reception step; an association step; a selection step; and a specification step. The reproduction step is for reproducing sound of each of a plurality of frequency components by a reproduction device. The indication reception step is for receiving, after the reproduction step, an indication indicating which component, out of the frequency components, is close to a component of an abnormal sound of which a generation point is to be specified, via a human interface. The association step is for associating sound data with image data and storing the sound data and the image data in a storage device, the sound data being recorded by a recording device that is arranged in proximity to each of a plurality of regions that are obtained by dividing a target object, the image data being a part of image data on the target object imaged by an imaging device, the part being related to the target object that is in proximity to the recording device at a time of recording. The selection step is for selecting, out of the sound data associated with the image data in the association step, the image data associated with the data that is highest in sound pressure level of an indication frequency component that is the frequency component indicated in the indication reception step. The specification step is for specifying the generation point of the abnormal sound based on the image data selected in the selection step.

The method enables a person to indicate the frequency component that is characteristic of a sound that the person feels abnormal by reproducing sound of each of a plurality of frequency components. Therefore, regardless of whether the sound pressure level of the sound that the person feels abnormal is the maximum sound pressure level of the sound generated from the target object, the abnormal sound can properly be grasped. The sound data recorded by the recording device that is arranged in proximity to each of a plurality of regions that are obtained by dividing a target object is stored in association with a part of the image data related to the target object that is in proximity to the recording device. By selecting the image data associated with the data highest in sound pressure level of the indication frequency component, the selected image data is highly likely to represent the image data close to the generation point of the abnormal sound. Therefore, it becomes possible to specify the generation point of the abnormal sound detected by the person.

2. The method according to the first aspect may include: a recording step of recording the sound generated from the target object with the recording device and storing the sound as sound data in the storage device; and an extraction step of extracting the frequency components of the sound indicated by the sound data. In the method according to the first aspect, the reproduction step may be a step of reproducing sound of each of the frequency components extracted in the extraction step.

In the method, the frequency components of the sound data are extracted and reproduced. This enables a person to specify the component that the person feels abnormal based on the sound that the person actually hear.

3. In the method according to the second aspect, the target object may include a rotary machine, and the frequency components may be predetermined components that are proportional to a rotational frequency of the rotary machine.

When the target object includes a rotary machine, the rotary machine or a rotor coupled to the rotary machine may generate abnormal sound with rotation. In that case, the frequency of the abnormal sound is proportional to the rotation frequency of the rotary machine. In the above method, the frequency components to be extracted are the predetermined components that are proportional to the rotational frequency of the rotary machine. This makes it possible to accurately extract the components of the abnormal sound generated with rotation of the rotary machine.

4. The method according to the third aspect may include a measurement result acquisition step of acquiring a measurement result by a device that measures a variable value indicating rotation speed of the rotary machine. The extraction step may have a step of extracting the frequency components based on the rotational frequency indicated by the measurement result.

In the method, frequency components are extracted based on the rotational frequency indicated by the measurement result. Accordingly, target components can accurately be extracted without having to fix the rotation speed of the rotary machine to predetermined values.

5. The method according to the third or fourth aspect may include an inquiry step of inquiring whether or not the component of the abnormal sound of which the generation point is to be specified is a component dependent on the rotational frequency of the rotary machine. The extraction step may include: a step of extracting a plurality of predetermined components independently of the rotational frequency of the rotary machine when a response as a result of the inquiry is that the component is not dependent, and a step of extracting predetermined components proportional to the rotational frequency of the rotary machine when the response as the result of the inquiry is that the component is dependent.

In the method, it is possible to obtain useful information to determine the type of abnormal sound by inquiring whether the component of the abnormal sound is dependent on the rotation frequency of the rotary machine.

6. In the method according to any one of the first to fifth aspects, the specification step may include a first probability calculation step of using the image data as input to calculate probability that one or more candidates of the generation point of the abnormal sound are points indicated by the image that is indicated by the above image data, a second probability calculation step of calculating probability that the one or more candidates of the generation point of the abnormal sound are actual generation points of the abnormal sound based on the sound data associated with the image data selected in the selection step, and a comprehensive probability calculation step of calculating comprehensive probability that the one or more candidates of the generation point of the abnormal sound are actual generation points of the abnormal sound based on a result of probability calculation in the first probability calculation step and a result of probability calculation in the second probability calculation.

In the above method, the generation point of the abnormal sound is specified based on the position information on the target object indicated by the image data when the sound pressure level of the specified frequency component is the highest, as well as on the sound data at that time. This makes it possible to specify the generation point of the abnormal sound with high accuracy as compared with the case of specifying based on only the position information.

7. In the method according to the sixth aspect, the second probability calculation step may be a step of calculating probability corresponding to one or more candidates of the generation point of the abnormal sound, based on similarity between the sound data associated with the image data selected in the selection step and waveform pattern data representing relationship between frequencies that are characteristic when the candidates of the generation point of the abnormal sound generate sound and sound pressure levels.

In the above method, the probability corresponding to candidates of the generation point is calculated based on the similarity between the sound data on the candidates of the generation point and waveform pattern data on the sound pressure levels relative to the frequencies. This makes it possible to specify the generation point of the abnormal sound by using specific frequency that is characteristic of the abnormal sound, as well as the sound pressure waveform when the abnormal sound is generated.

8. In the method according to any one of the first to seventh aspects, the first probability calculation step may be a step of using the image data as input to calculate probability corresponding to the candidates of the generation point indicated by the image data. The second probability calculation step may be a step of calculating probability corresponding to the candidates of the generation point of the abnormal sound, based on similarity between the sound data associated with the image data selected in the selection step and waveform pattern data representing relationship between frequencies that are characteristic when the candidates of the generation point generate sound and sound pressure levels.

In the method, the recording device as well as the imaging device are arranged in proximity to each of a plurality of regions obtained by dividing a target object. This makes it easy to associate the recorded sound with the position information on the target object that faces the recording device.

9. An application program that causes a computer to execute the reproduction step, the indication reception step, the association step, and the selection step in the method of specifying a generation point of abnormal sound according to any one of the first to eighth aspects.

10. The application program according to the ninth aspect may cause the computer to execute: a transmission step of transmitting the image data selected in the selection step and the sound data associated with the image data; and a reception step of receiving a signal indicating information regarding the generation point of the abnormal sound specified in the specification step based on the image data and the sound data transmitted in the transmission step.

The above method allows the computer to execute the transmission step and reception step. Accordingly, another computer other than the computer can execute the specification step. Therefore, a computational load of the computer executing the reproduction step and other steps can be reduced as compared with the case where the computer also executes the specification step.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 shows the configuration of an abnormal sound generation point specification system according to an embodiment;

FIG. 2 is a flowchart showing processing procedures executed by a mobile terminal according to the embodiment;

FIG. 3A shows processing executed by the mobile terminal and steps executed by a person;

FIG. 3B shows processing executed by the mobile terminal and steps executed by a person;

FIG. 3C shows processing executed by the mobile terminal and steps executed by a person;

FIG. 4 shows data prescribing the frequency components of abnormal sound in rotational synchronization according to the embodiment;

FIG. 5A shows processing procedures executed by the mobile terminal and an analyzer;

FIG. 5B shows processing procedures executed by the mobile terminal and an analyzer;

FIG. 6 illustrates waveform data according to the embodiment; and

FIG. 7 is a plan view showing a display example of the mobile terminal according to the embodiment.

### DETAILED DESCRIPTION OF EMBODIMENTS

Hereinafter, an embodiment of the present disclosure will be described with reference to the drawings.

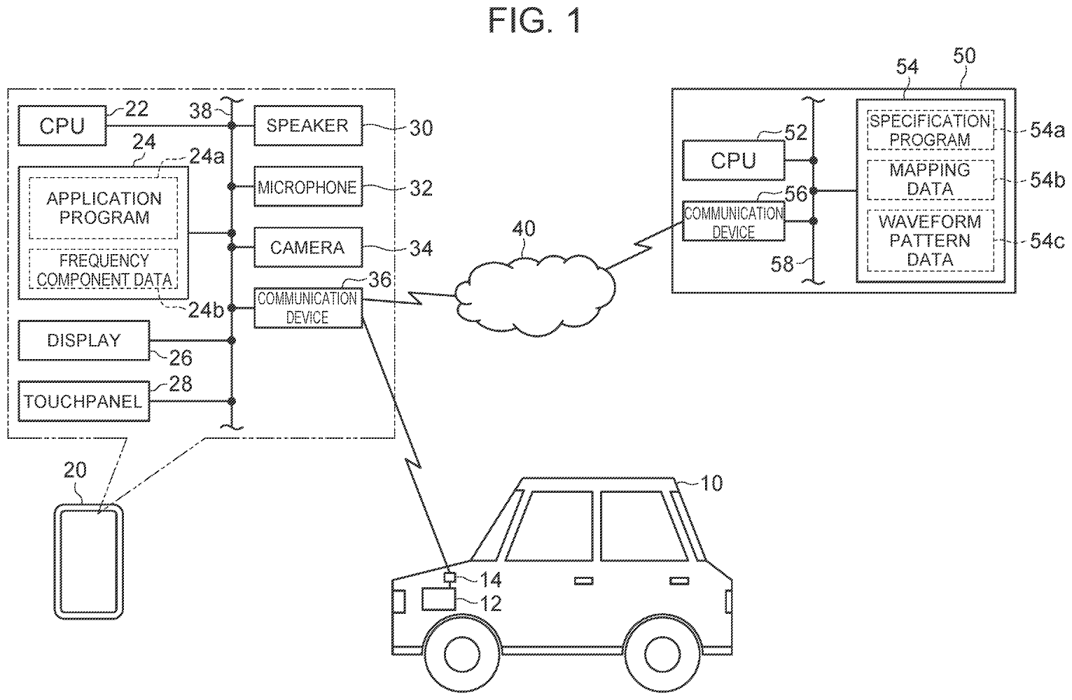

FIG. 1 shows a system for specifying a generation point of abnormal sound according to the embodiment.

A vehicle 10 is a vehicle brought into a repair shop by a user who detects abnormal sound. The vehicle 10 is mounted with an internal combustion engine 12 and a control device 14 of the internal combustion engine 12. The repair shop may also be a dealer shop.

A mobile terminal 20 is a portable terminal possessed by an operator at the repair shop. The mobile terminal 20 includes a CPU 22, a storage device 24, a display 26, a touchpanel 28, a speaker 30, a microphone 32, a camera 34 and a communication device 36, which can communicate with each other via a communication line 38. Here, the storage device 24 is an electrically rewritable, non-volatile memory. The display 26 is constituted of, for example, an LCD or an LED. The touchpanel 28 is arranged so as to be superimposed on the display 26. The communication device 36 can communicate with the control device 14 of the vehicle 10. The communication device 36 can also communicate with an analyzer 50 possessed by a vehicle manufacturer via a network 40.

The analyzer 50 includes a CPU 52, a storage device 54, and a communication device 56, which can communicate via a communication line 58. The storage device 54 is an electrically rewritable, non-volatile memory.

The storage device 24 of the mobile terminal 20 stores an application program 24a. The storage device 54 of the analyzer 50 stores a specification program 54a. The CPU 22 executes instructions defined by the application program 24a, and the CPU 52 executes instructions defined by the specification program 54a so as to perform processing to specify abnormal sound generated in the vehicle 10. Hereinafter, the processing will be described in detail.

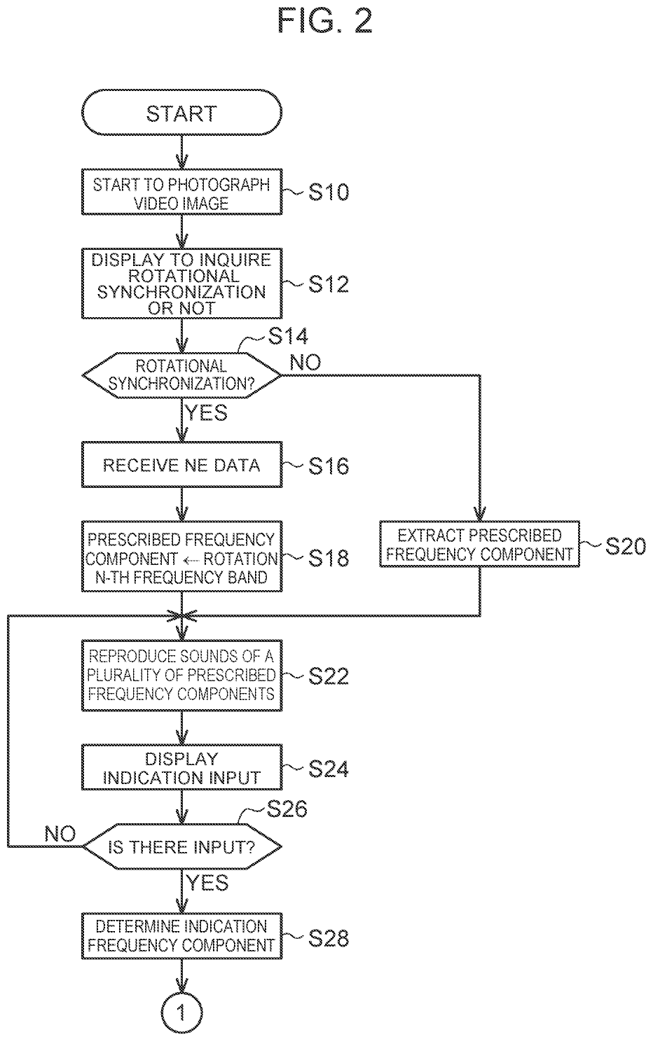

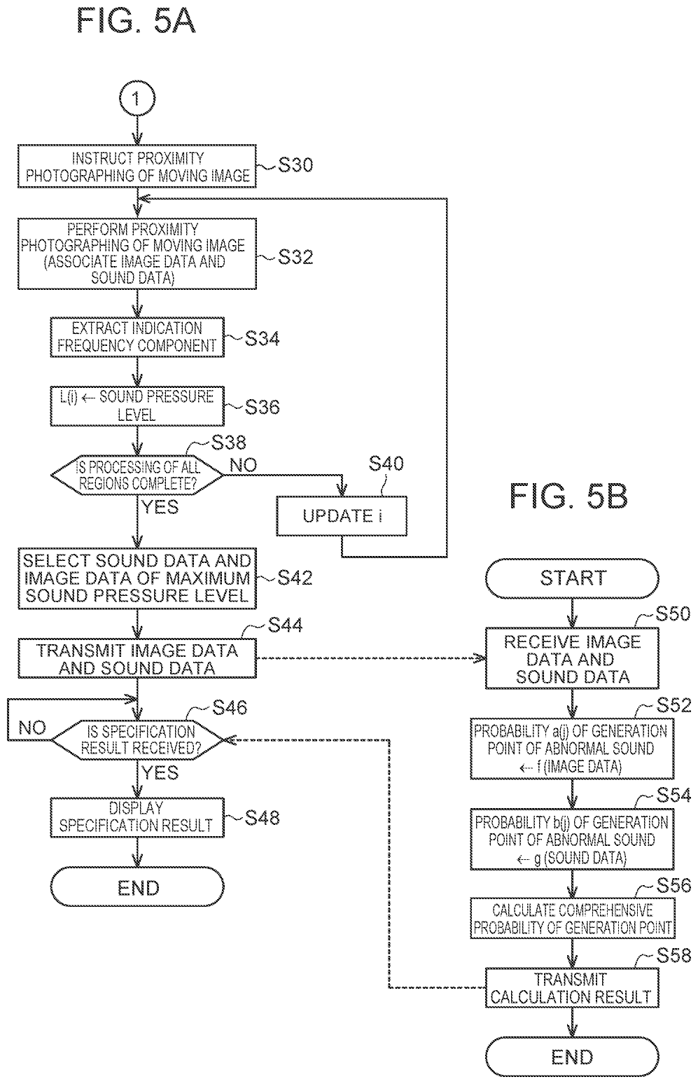

FIGS. 2 and 5A show the processing procedures defined by the application program 24a. The processing shown in FIGS. 2 and 5A are implemented when the CPU 22 executes the processing whenever a prescribed condition is established, for example. FIG. 5B shows the processing procedures defined by the specification program 54a. The processing shown in FIG. 5B is implemented when the CPU 52 executes the processing whenever a prescribed condition is established, for example. Hereinafter, the step number of each process will be expressed by numerals prepended with “S”.

In a series of processing shown in FIG. 2, the CPU 22 first photographs a video image of a target object in the vicinity of the point where an abnormal sound is generated (S10). Specifically, the CPU 22 uses the camera 34 to photograph the target object, while using the microphone 32 to record surrounding sound. The processing may be achieved by, for example, outputting guidance information to urge photographing a video image of the target object when the application program 24a for specifying the generation point of the abnormal sound is started. Here, the guidance information may be output as visual information by operating the display 26, or as audible information by operating the speaker 30.

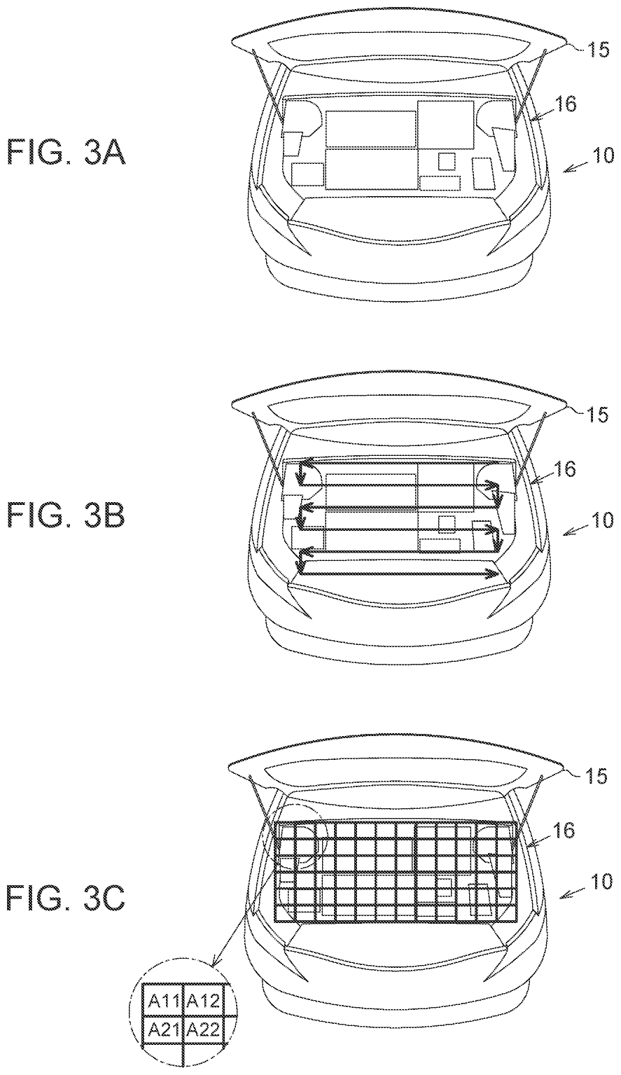

FIG. 3A shows the case where the target object is an object housed in an engine compartment 16. In this case, in accordance with an instruction given by the mobile terminal 20, the operator opens the hood 15 and starts to photograph a video image of the entire object housed in the engine compartment 16. In other words, the operator starts to photograph a video image of the entire target object.

With reference to FIG. 2 again, the CPU 22 operates the display 26 to inquire whether the abnormal sound is the sound that synchronizes with rotation speed of the internal combustion engine 12 (S12). In this case, the CPU 22 may display a supplementary explanation on the display 26 stating that when the frequency of the abnormal sound changes as the rotation speed of the internal combustion engine 12 changes due to operation of an accelerator or the like, then the sound is caused by synchronization.

The CPU 22 then determines whether input operation performed on the touchpanel 28 is input operation indicating the rotational synchronization or input operation indicating no synchronization (S14). When it is determined that the input operation indicates synchronization (S14: YES), the CPU 22 communicates with the control device 14 to receive data about rotation speed NE of a crank shaft that is a rotation shaft of the internal combustion engine 12 (S16). The CPU 22 then sets the frequency band of n-th order rotation as a prescribed frequency component that is characteristic as a candidate of the abnormal sound, based on the rotation speed NE (S18). In this process, the CPU 22 refers to frequency component data 24b stored in the storage device 24 shown in FIG. 1.

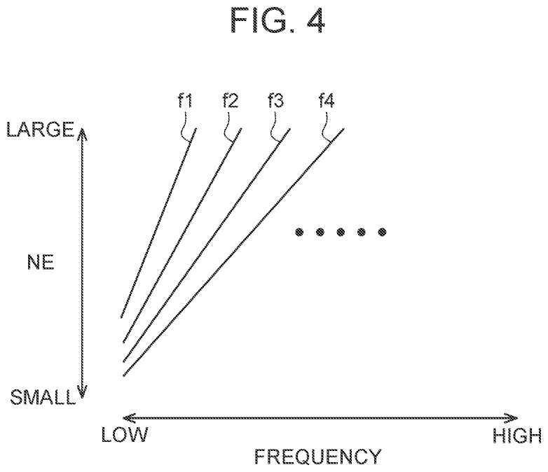

FIG. 4 illustrates the frequency component data 24b.

As shown in FIG. 4, the frequency component data 24b is data that defines the relationship between the rotation speed NE and the frequency of the abnormal sound for each of a plurality of candidates of the generation point of the abnormal sound. In FIG. 4, line segments f1, f2, . . . define the relationship of the frequency with the rotation speed NE. The line segments f1, f2, . . . each indicate relationship between the rotation speed NE relating to the candidates of the generation point of the abnormal sound and the frequency of generated sound. These candidates may include, for example, an oil pump that circulates lubricating oil of the internal combustion engine 12, and may include, for example, a chain that transmits the power of the crank shaft to a cam shaft.

The process of S18 is to set frequency bands that are defined based on the line segments f1, f2, . . . and the rotation speed NE. In other words, the number of the frequency bands set as prescribed frequency bands here is equal to the number of the line segments f1, f2, . . . .

With reference to FIG. 2 again, when it is determined that the input operation indicates no synchronization (S14: NO), the CPU 22 sets as the prescribed frequency bands, a plurality of frequency bands characteristic of the abnormal sound independent of the rotation speed NE (S20). This process can be achieved by setting a characteristic frequency band for each candidate of the generation point of sound not synchronized with the rotation speed NE in the frequency component data 24b.

When the processes of S18 and S20 are completed, the CPU 22 operates the speaker 30 to reproduce sounds of a plurality of frequency bands set in the process of S18 or the process of S20 (S22). This process can be achieved by band-pass filter processing applied to the sounds recorded in the process of S10 and thereby generating data on sounds in the frequency bands set by the process of S18 or process of S20.

The CPU 22 then operates the display 26 to display visual information for urging a user to indicate the sound closest to the abnormal sound among the reproduced sounds (S24). The CPU 22 continues the processes of S22 and S24 until the frequency band closest to the abnormal sound is indicated (S26: NO) by input operation performed on the touchpanel 28. Specifically, the processes of S22 to S26 may be performed by the CPU 22 to display the number of buttons, corresponding to the number of the frequency bands to be reproduced, on the display 26, with the button currently selected for reproduction being displayed in color different from other buttons. In other words, when a specific button is indicated via the touchpanel 28, the CPU 22 may determine that the sound closest to the abnormal sound is indicated.

When it is determined that there is input operation indicating the sound closest to the abnormal sound (S26: YES), the CPU 22 determines the indicated band as the indication frequency band (S28).

Then, the CPU 22 operates the display 26 as shown in FIG. 5A to make an instruction to photograph a video image by arranging the mobile terminal 20 to face each of a plurality of regions obtained by dividing the target object (S30). Specifically, the CPU 22 displays on the display 26 a moving path of the mobile terminal 20 that is superimposed on the entire image of the target object photographed by the process of S10.

FIG. 3B shows a display example of the display 26. FIG. 3B shows an example of the moving path of the mobile terminal 20 that is moved three times from left side to right side while the position of the mobile terminal 20 being shifted in a vehicle front-rear direction. Specifically, FIG. 3B shows an example of the moving path in which the mobile terminal 20 is moved within the engine compartment 16 such as from a rear left side to the rear right side of the vehicle and then to the front side of the vehicle 10.

For proximity photographing of a moving image, it is desirable that a distance between the target object and the mobile terminal 20, and the speed of moving the mobile terminal 20 are set in advance and the operator performs the processing based on the set distance and speed. This can be achieved by, for example, giving an instruction regarding the distance and speed by operating the display 26 or the speaker 30 in the process of S30 shown in FIG. 5A. This process can be substituted for giving instructions in an operation manual.

When proximity photographing of the moving image is started by operation of the operator, the CPU 22 stores image data from the camera 34 and sound data from the microphone 32 in the storage device 24 for each region obtained by dividing the target object (S32).

FIG. 3C shows an example of divided regions. In the example shown in FIG. 3C, the target object is divided into six parts in the front-rear direction of the vehicle 10 and 12 parts in the right-left direction. In the example shown in FIG. 3C, the target object is divided into a plurality of regions A11, A12, . . . , A21, A22, . . . .

Dividing the target object into regions can be achieved when, for example, the CPU 22 determines the position of the image indicated by the proximity video image in an overall image stored by the process of S10. Instead of determining the position, the CPU 22 may display on the display 26 the current position on the moving path shown in FIG. 3B, and specify the regions based on the assumption that the mobile terminal 20 is arranged in proximity to the displayed position. Here, for example, the region A11 is a region of the target object that faces the mobile terminal 20 that is arranged in proximity to the target object. Therefore, the process of S32 stores image data about a part of the target object that is in proximity to the mobile terminal 20 in association with the sound data at that time.

With reference to FIG. 5A again, the CPU 22 extracts an indication frequency component from the sound recorded by the microphone 32 when the mobile terminal 20 is arranged in proximity (S34). The CPU 22 then assigns the sound pressure level of the indication frequency component to a sound pressure level L(i) identified by a label variable i indicating the current region (S36).

The CPU 22 performs processes of S32 to S36 for all the regions of the target object. In other words, when it is determined that processing for all the regions are not yet complete (S38: NO), the CPU 22 updates the label variable i (S40) and returns to the process of S32. Contrary to this, when it is determined that processing for all the regions are complete (S38: YES), the CPU 22 selects the image data and the sound data corresponding to the maximum sound pressure level L(i), among the image data and the sound data stored by the process of S32 (S42). The CPU 22 then operates the communication device 36 to transmit the selected image data and sound data to the analyzer 50 (S44).

In this connection, as shown in FIG. 5B, the CPU 52 of the analyzer 50 receives the transmitted image data and sound data (S50). The CPU 52 then inputs the image data into mapping defined by mapping data 54b stored in the storage device 54 shown in FIG. 1 to calculate a first probability a(j) regarding each of candidates j of the generation point of the abnormal sound (S52). Here, the mapping is a convolutional neural network (CNN) using Softmax function as an activation function in an output layer. The number of dimensions of the output layer is the number of candidates of the generation point of abnormal sound. The value of each node in the output layer indicates the probability that the corresponding candidate is the generation point of the abnormal sound.

The mapping defined by the mapping data 54b is a learned model that is learned using the image data and training data that sets the value of a node corresponding to the object indicated by the image data to “1” and the value of other nodes to “0”.

The CPU 52 then calculates a second probability b(j) regarding the candidates j of the generation point of the abnormal sound based on the waveform of the sound pressure level corresponding to the frequency indicated by the received sound data (S54). The process is based on the similarity between a waveform pattern indicated by waveform pattern data 54c for each of the candidates of the generation point of the abnormal sound stored in the storage device 54 shown in FIG. 1, and the waveform of the sound pressure level corresponding to the frequency indicated by the received sound data.

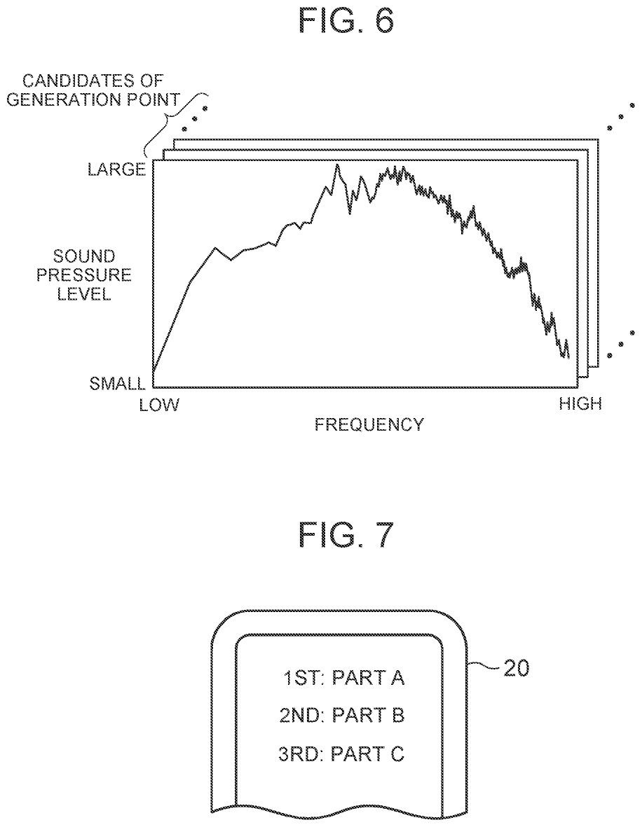

FIG. 6 shows the waveform pattern data 54c. As shown in FIG. 6, the waveform pattern data 54c indicates, for each of the candidates of the generation point of abnormal sound, the waveform pattern representing the relationship between the frequency of the sound generated from the entire target object and the sound pressure level when the abnormal sound is generated. Here, the frequency in the waveform pattern of one candidate is not limited to the frequency that is characteristic of the abnormal sound generated from the candidate. Rather, the frequency is in a wide frequency band incorporating the characteristic frequency. This is the process of identifying the generation point of the abnormal sound based on sound information that is typical when the abnormal sound is generated. Accordingly, even when a plurality of generation points of an abnormal sound generate the abnormal sound having the same order frequency as the rotation frequency of the crank shaft, it becomes possible to identify which generation point generates the abnormal sound.

When, among the waveform patterns indicated by the waveform pattern data 54c, some waveform patterns are below a prescribed similarity to the waveform of the sound pressure level corresponding to the frequency indicated by the received sound data, the CPU 52 may set the second probability b that the candidates corresponding to the patterns are the generation point of the abnormal sound to “0”.

With reference to FIG. 5B again, the CPU 52 calculates the comprehensive probability for each of the candidates based on the first probability a(j) and the second probability b(j) (S56). Specifically, the CPU 52 defines, for each of the candidates, a product of the first probability a and the second probability b as the comprehensive provability.

The CPU 52 then operates the communication device 56 to transmit the result of specifying the generation point of the abnormal sound to a transmission source of the data received by the process of S50 (S58). Here, the CPU 52 transmits information about three candidates of the generation point higher in the comprehensive probability. The CPU 52 temporarily ends a series of the processes shown in FIG. 5B, when the process of S58 is completed.

In contrast, as shown in FIG. 5A, upon reception of the specification result (S46: YES), the CPU 22 of the mobile terminal 20 operates the display 26 to display the received information as visual information (S48).

FIG. 7 shows a display example displayed on the display 26 of the mobile terminal 20. As shown in FIG. 7, parts A, B, C are listed in descending order of the comprehensive probability.

The CPU 22 temporarily ends a series of processing shown in FIGS. 2 and 5A, when the process of S48 is completed.

Now, the functions and effects of the present embodiment will be described.

When an abnormal sound of which generation point is expected to be specified, is proportional to the rotation frequency of the crank shaft, the CPU 22 reproduces sounds of frequencies corresponding to candidates of the generation point, which are component parts that can generate proportional abnormal sounds. When the operator indicates the frequency closest to the abnormal sound, out of the reproduced sounds, the CPU 22 sets the frequency as an indication frequency. The CPU 22 then photographs images and records sounds when mobile terminal 20 is arranged in proximity to a plurality of regions obtained by dividing the target object. Then, the CPU 22 calculates the sound pressure level of the indication frequency component among the recorded sounds, and stores the calculated sound pressure level. The CPU 22 selects the region, out of the regions, highest in recorded sound pressure level, and transmits the image data and sound data on the region to the analyzer 50.

The CPU 52 of the analyzer 50 calculates the first probability a that the object, indicated by the transmitted image data, is each of the candidates of the generation point. The CPU 52 also calculates the second probability b that each of the candidates of the generation point is actually the generation point of the abnormal sound, based on the similarity between the waveform indicated by the transmitted sound data and the waveform indicated by the waveform pattern data 54c. Then, the CPU 52 multiplies values of the first probability a and the second probability b of the same candidate to obtain the comprehensive probability of the candidate, and transmits the obtained comprehensive probability to the CPU 22. The CPU 22 displays the transmitted result of specifying the generation point of the abnormal sound.

This makes it possible to calculate the generation point of the abnormal sound with high accuracy. Specifically, for example, since the frequency of inverse number of the time interval at a compression top dead center of the internal combustion engine 12 is the frequency of inverse number of the period of a combustion phase, generated sound has a frequency with a high sound pressure level. However, the sound sensed as abnormal sound is not necessarily the sound of this frequency. Therefore, it is difficult to grasp which sound the user recognizes as abnormal sound based only on the frequency analysis of the sound data. On the contrary, in the present embodiment, sounds of frequencies that are characteristic as the candidates of the generation point of abnormal sound are reproduced, and a person indicates which sound of frequency is close to the abnormal sound. This makes it possible to correctly understand the abnormal sound and then specify the generation point thereof. As a result, it is possible to grasp the generation point of the abnormal sound with high accuracy.

According to the present embodiment described in the foregoing, the functions and effects as described below are further achieved.

(1) An indication frequency component is extracted from the sounds recorded when the mobile terminal 20 is arranged in proximity to each of a plurality of regions obtained by dividing a target object, and the point with a highest sound pressure level is specified. Accordingly, even in the case where an operator who heard abnormal sound has an incorrect preconception regarding the generation point of the abnormal sound, it is possible to specify the place highly likely to generate the sound of the indication frequency regardless of the preconception.

(2) In the case of abnormal sound proportional to the rotation frequency of the crank shaft, the rotation speed NE is obtained from the control device 14. Based on the rotation speed NE, frequency components, characteristic of the sound generated by each of the candidates of the generation point of the abnormal sound, are extracted. Accordingly, a target component can accurately be extracted without having to fix the rotation speed NE of the crank shaft to predetermined values.

(3) An inquiry is made to a person regarding whether the abnormal sound is proportional to the rotation frequency of the crank shaft. As a result, it is possible to obtain useful information to determine the type of abnormal sound.

(4) The CPU 52 calculates the first probability a that each of the candidates is the generation point, from the image data when the indication frequency is at its maximum, and calculates the second probability b that each of the candidates is the generation point, based on the similarity between the waveform indicated by the sound data with the frequency at its maximum and the waveform indicated by the waveform pattern data 54c. This makes it possible to specify the generation point of the abnormal sound by using the indication frequency that is a specific frequency characteristic of the abnormal sound as well as the sound pressure waveform when the abnormal sound is generated. Accordingly, even when the frequencies generated by a plurality of generation candidates are the same-order frequencies as the rotation frequency of the crank shaft, it becomes possible to specify which of these candidate is the generation point.

(5) The analyzer 50 executes the processes of S52 and S54. This makes it possible to reduce the computational load on the mobile terminal 20 as compared with the case where the processes of S52 and S54 are executed by the mobile terminal 20.

Correspondence Relation

The correspondence relation between the matters in the embodiments and the matters described in the column “Solution to Problem” is as follows. In the followings, the correspondence relation is shown for every number of the solutions stated in the column “Solution to Problem”. [1, 8] The target object corresponds to the object housed in the engine compartment 16 shown in FIG. 3A. The storage device corresponds to the storage device 24. The reproduction device corresponds to the speaker 30. The reproduction step corresponds to the process of S22. The indication reception step corresponds to the process of S24 and S26. The association step corresponds to the process of S32. The selection step corresponds to the processes of S34 to S42. The specification step corresponds to the processes of S52 to S56. [2] The recording step corresponds to the process of S10. The extraction step corresponds to the processes of S18 and S20. [3] The rotary machine corresponds to the internal combustion engine 12. [4] The device that measures corresponds to the control device 14. The measurement result acquisition step corresponds to the process of S16. [5] The inquiry step corresponds to the process of S12. [6] The first probability calculation step corresponds to the process of S52. The second probability calculation step corresponds to the process of S54. The comprehensive probability calculation step corresponds to the process of S56. [7] The pattern data corresponds to the waveform pattern data 54c. [9] The application program corresponds to the application program 24a. [10] The transmission step corresponds to the step of executing the process of S44. The reception step corresponds to the step of executing the process of S46.

### Other Embodiments

The present embodiment can be implemented with modifications as shown below. The present embodiment and following modifications can be implemented in combination with each other without departing from the range of technically consistency.

About Rotary Machine
The rotary machine included in the vehicle is not limited to an internal combustion engine, and may be a motor generator, for example.
The rotary machine is not limited to those included in the vehicle.

About Measurement Result Acquisition Step
In the above embodiment, the rotation speed NE is transmitted in real time from the control device 14 during recording of sound. However, the present disclosure is not limited to the configuration. For example, the rotation speed NE acquired each time may be associated with the time of measurement and stored in the control device 14. Upon request from the mobile terminal 20, the control device 14 may collectively transmit time series data on the rotation speed NE and the time information.
For example, when the rotation speed of the rotary machine, such as the internal combustion engine 12, is controlled to a predetermined value at the time of recording, reception of data regarding the rotation speed NE may be omitted.

About Inquiry Step
In the embodiment, the inquiry step is executed after the start of recording. However, without being limited to this, the recording may be started after the inquiry process is completed.
For example, the application program 24a may be formed as a program specialized in specifying abnormal sound that is synchronized with rotation, and the processes of S12, S14, S20 may be removed. In other words, in this case, the inquiry process can be omitted.

About Reproduction Step and Indication Reception Step
In the embodiment, in the process of S22, reproduction data is created by band-pass filter processing applied to the sound data recorded in the process of S10. However, the present disclosure is not limited to the configuration. For example, sample sound source data may be included in the frequency component data 24b, and be reproduced.
In the embodiment, sounds of a plurality of frequency components are sequentially reproduced on the side of the mobile terminal 20, and then a person is urged to indicate the sound of which generation point is expected to be specified. However, the present disclosure is not limited to the configuration. For example, buttons assigned with the frequency components may be displayed on the display 26, and the sound of the frequency components corresponding to the pressed button may be reproduced. In this case, for example, long-press of the button may be defined as an operation to indicate the sound of which generation point is expected to be specified.
The human interface operated by a person to indicate the sound of which generation point is expected to be specified is not limited to the touchpanel 28. For example, a microphone 32 may be employed as the human interface, and voice input operation may be used to indicate the sound of which generation point is expected to be specified.

About Association Step
In the embodiment, image data and sound data on a part of the target object that faces the mobile terminal 20 are associated by photographing video image and recording sound while the mobile terminal 20 is arranged in proximity to the target object. However, the present disclosure is not limited to the configuration. For example, each time the mobile terminal 20 is slightly relocated, a still image of the part of the target object facing the mobile terminal 20 may be photographed, and the sound recorded while the mobile terminal 20 is fixed may be associated with the corresponding still image data.
It is not essential to photograph images of the target object when the mobile terminal 20 is arranged in proximity to the target object. For example, after photographing a video image or a still image of the entire target object, a portion of the entire image of the target object may be marked and displayed as the point where the mobile terminal 20 is to be arranged in proximity. In this case, the sound data recorded by the mobile terminal 20 when the marked point is displayed may be regarded as the sound data recorded while the mobile terminal 20 is arranged in proximity to the marked point. This makes it possible to associate the image data on the marked point with the sound data recorded in proximity to the marked point.

About First Probability Calculation Step
In the embodiment, dimensionality of output variables of mapping is equal to the number of candidates of the generation point. However, the dimensionality is not limited to this. For example, the dimensionality may be the number of the candidates of the generation point plus “1”, to add an output variable indicating the probability that no candidate is the generation point.

About Second Probability Calculation Step
In the embodiment, the probability of the generation point is calculated based on the similarity between the waveform of the sound pressure level corresponding to the frequency of sound data when the sound pressure level of the indication frequency component is at its maximum and the pattern of waveform data for each candidate of the generation point of abnormal sound. However, the calculation of the probability is not limited to this. For example, the probability may be calculated with a learned model that outputs the probability of each candidate of the generation point by using as the input variable the sound pressure level of each frequency indicated by the sound data when the sound pressure level of the indication frequency component is at its maximum. Here, the learned model may be a neural network, for example. However, without being limited thereto, the learned model may be, for example, an identification model using a support vector machine. It is also possible to use a decision tree, for example. The learning model is also not limited to those outputting the probability of each candidate of the generation point in a single input. It is also possible to use a recurrent neural network, such as LSTM, in which input variables are input for a plurality of times to provide precise output values.

About Comprehensive Probability
In the embodiment, the comprehensive probability is calculated as a product of the first probability a and the second probability b. However, the comprehensive probability is not limited to this. For example, the comprehensive probability may be a sum of the first probability a and the second probability b.

About Display of Specification Result
In the embodiment, the three candidates higher in probability of being an actual generation point are displayed. However, the number of the candidates to be displayed is not limited to three. For example, the top candidate may be displayed, or higher five candidates may be displayed.
In the embodiment, only the candidates of the generation point are displayed. However, the probability of the candidates being an actual generation point may also be displayed at the same time.

About Computer that Executes Processing to Specify Generation Point
In the embodiment, the processing to specify the generation point of abnormal sound is executed in cooperation with the CPU 22 of the mobile terminal 20 and the CPU 52 of the analyzer 50. However, the processing configuration is not limited to this. For example, the CPU 22 of the mobile terminal 20 may also execute the processes of S52 to S56. For example, a computer with a built-in scanning tool provided in a repair shop may execute the processing shown in FIG. 5B in place of the analyzer 50 provided in the manufacturer. For example, a computer that processes big data, independent of the manufacturer, may execute the processing shown in FIG. 5B. For example, the computer that executes the processing shown in FIGS. 2 and 5A may be built into the user's mobile terminal, and the computer that executes the processing shown in FIG. 5B may be built into the mobile terminal possessed by the operator at the repair shop.

About Computer

The computer is not limited to those executing software processing. The computer may include a dedicated hardware circuit for hardware processing, such as ASICs. The computer may further be a combination of a software execution device that executes programs and the dedicated hardware processing circuit. Specifically, the computer may have any one of the configurations (a) to (c) below: (a) including a software execution device that executes all the processing based on programs; (b) including a software execution device that executes some of the processing based on programs, and a dedicated hardware circuit that executes the remaining processing; and (c) including a dedicated hardware circuit that executes all the processing. Here, the number of the software execution devices, or the number of the dedicated hardware circuits may be two or more.

About Target Object as Specification Target of Generation Point of Abnormal Sound
In the embodiment, an object housed in the engine compartment is illustrated as the target object. However, the target object is not limited to this. For example, processing may be performed to specify the generation point of abnormal sound in an instrument panel in the vehicle cabin. Furthermore, the abnormal sound is not limited to sound generated in the vehicle.

What is claimed is:

1. A method of specifying a generation point of abnormal sound, comprising:
a reproduction step of reproducing sound of each of a plurality of frequency components by a reproduction device;
an indication reception step of receiving, after the reproduction step, an indication indicating which component, out of the frequency components, is close to a component of an abnormal sound of which a generation point is to be specified, via a human interface;
an association step of associating sound data with image data and storing the data in a storage device, the sound data being recorded by a recording device that is arranged in proximity to each of a plurality of regions that are obtained by dividing a target object, the image data being a part of image data on the target object imaged by an imaging device, the part being in proximity to the recording device at a time of recording;
a selection step of selecting, out of the sound data associated with the image data in the association step, the image data associated with the data that is highest in sound pressure level of an indication frequency component that is the frequency component indicated in the indication reception step; and
a specification step of specifying the generation point of the abnormal sound based on the image data selected in the selection step.

2. The method according to claim 1, comprising:
a recording step of recording the sound generated from the target object with the recording device and storing the sound as sound data in the storage device; and
an extraction step of extracting the frequency components of the sound indicated by the sound data, wherein
the reproduction step is a step of reproducing sound of each of the frequency components extracted in the extraction step.

3. The method according to claim 2, wherein:
the target object includes a rotary machine; and
the frequency components are predetermined components that are proportional to a rotational frequency of the rotary machine.

4. The method according to claim 3, comprising a measurement result acquisition step of acquiring a measurement result by a device that measures a variable value indicating rotation speed of the rotary machine, wherein
the extraction step has a step of extracting the frequency components based on the rotational frequency indicated by the measurement result.

5. The method according to claim 3, comprising an inquiry step of inquiring whether or not the component of the abnormal sound of which the generation point is to be specified is a component dependent on the rotational frequency of the rotary machine, wherein
the extraction step includes
a step of extracting a plurality of predetermined components independently of the rotational frequency of the rotary machine when a response as a result of the inquiry is that the component is not dependent, and
a step of extracting predetermined components proportional to the rotational frequency of the rotary machine when the response as the result of the inquiry is that the component is dependent.

6. The method according to claim 1, wherein:
the specification step includes
a first probability calculation step of using the image data as input to calculate probability that one or more candidates of the generation point of the abnormal sound are points indicated by the image that is indicated by the image data,
a second probability calculation step of calculating probability that the one or more candidates of the generation point of the abnormal sound are actual generation points of the abnormal sound based on the sound data associated with the image data selected in the selection step, and
a comprehensive probability calculation step of calculating comprehensive probability that the one or more candidates of the generation point of the abnormal sound are actual generation points of the abnormal sound based on a result of probability calculation in the first probability calculation step and a result of probability calculation in the second probability calculation step.

7. The method according to claim 6, wherein the second probability calculation step is a step of calculating probability corresponding to one or more candidates of the generation point of the abnormal sound, based on similarity between the sound data associated with the image data selected in the selection step and waveform pattern data representing relationship between frequencies that are characteristic when the candidates of the generation point of the abnormal sound generate sound and sound pressure levels.

8. The method according to according to claim 1, wherein the association step is a step of associating the sound data recorded with the recording device and the image data imaged with the imaging device when the two devices including the recording device and the imaging device are arranged in proximity to each of the regions that are obtained by dividing the target object.

9. An application program that causes a computer to execute the reproduction step, the indication reception step, the association step, and the selection step in the method of specifying a generation point of abnormal sound according to claim 1.

10. The application program according to claim 9, wherein
the application program causes the computer to execute:
a transmission step of transmitting the image data selected in the selection step and the sound data associated with the image data; and
a reception step of receiving a signal indicating information regarding the generation point of the abnormal sound specified in the specification step based on the image data and the sound data transmitted in the transmission step.
